(19) United States
(12) Patent Application Publication
(10) Pub. No.: US 2017/0146716 A1
(43) Pub. Date: May 25, 2017

(54) LIGHT GUIDE PLATE, BACKLIGHT MODULE AND DISPLAY DEVICE

(71) Applicants: Radiant Opto-Electronics (Suzhou) Co., Ltd., Wujiang Jiangsu (CN); Radiant Opto-Electronics Corporation, Kaohsiung (TW)

(72) Inventors: Chia-Yin Chang, KAOHSIUNG (TW); Chin-Ting Weng, KAOHSIUNG (TW); Po-Chang Huang, KAOHSIUNG (TW); Shin-Bo Lin, KAOHSIUNG (TW); Yue-Heng Lee, KAOHSIUNG (TW)

(21) Appl. No.: 15/341,191

(22) Filed: Nov. 2, 2016

Related U.S. Application Data
(63) Continuation-in-part of application No. PCT/CN2015/099808, filed on Dec. 30, 2015.

(30) Foreign Application Priority Data
Nov. 20, 2015 (CN) 201510811306.X

(51) Int. Cl. F21V 8/00

(52) U.S. Cl. CPC G02B 6/0016; G02B 6/0068; G02B 6/002

(57) ABSTRACT

A light guide plate, a backlight module and a display device are provided. The light guide plate includes a main body, plural first microstructure portions and plural second microstructure portions. The main body includes a light-incident surface and an optical surface. The light-incident surface is connected to the optical surface, and the optical surface includes a first area. The first microstructure portions are disposed on the first area of the optical surface. The second microstructure portions are disposed on the first area of the optical surface, in which the second microstructure portions and the first microstructure portions are alternately arranged and aligned with each other, and the first microstructure portions are different from the second microstructure portions.

### RELATED APPLICATIONS

This application is a continuation-in-part application of International Application No. PCT/CN2015/099808 filed Dec. 30, 2015, which claims priority from China Patent Application Serial Number 201510811306.X, filed Nov. 20, 2015. The entire contents of each of which are incorporated by reference.

### BACKGROUND

Field of Invention

The present invention relates to a light guide element and its application. More particularly, the present invention relates to a light guide plate and its applications in a backlight module and a display apparatus.

Description of Related Art

A conventional backlight module mainly includes a light bar and a backlight plate. The light bar includes a circuit board and plural light-emitting diodes disposed on the circuit board. The light guide plate is disposed adjacent to the light-emitting diodes, and a light-incident surface of the light guide plate contacts a light-emitting surface of each of the light-emitting diodes, thereby effectively using light generated from the light-emitting diodes.

However, because the light-incident surface of the light guide plate contacts the light-emitting surface of each light-emitting diode, a hotspots phenomenon or a non-uniform brightness phenomenon is likely to occur on a portion of the light guide plate adjacent to the light-emitting diodes, thus affecting the optical appearance of the light guide plate.

### SUMMARY

One object of the present invention is to provide a light guide plate, a backlight module and a display device, in which plural microstructure portions are used to mix light leaked from a light-incident side of the light guide plate, so as to reduce the non-uniform brightness phenomenon adjacent to the light-incident side of the light guide plate and increase illumination uniformity of the backlight module.

According to the aforementioned object, a light guide plate is provided. The light guide plate includes a main body, plural first microstructure portions and plural second microstructure portions. The main body includes a light-incident surface and an optical surface. The light-incident surface is connected to the optical surface, and the optical surface includes a first area. The first microstructure portions are disposed on the first area of the optical surface. The second microstructure portions are disposed on the first area of the optical surface, in which the second microstructure portions and the first microstructure portions are alternately arranged and aligned with each other, and the first microstructure portions are different from the second microstructure portions.

According to an embodiment of the present invention, each of the first microstructure portions has plural first microstructures extending along a first axial direction. Each of the second microstructure portions has plural second microstructures extending along the first axial direction. The first microstructure portions and the second microstructure portions are alternately arranged along a second axial direction which is different from the first axial direction.

According to an embodiment of the present invention, the optical surface further includes a plain area located between the light-incident surface and the first area.

According to an embodiment of the present invention, the plain area and the first area are arranged along a first axial direction, and the second microstructure portions and the first microstructure portions are arranged along a second axial direction which is different from the first axial direction.

According to an embodiment of the present invention, each of the first microstructure portions has plural first microstructures extending along a first axial direction. Each of the second microstructure portions has plural second microstructures extending along the first axial direction.

According to an embodiment of the present invention, a length of each of the first microstructures is different from a length of each of the second microstructures.

According to an embodiment of the present invention, each of the first microstructures and the second microstructures is a concave structure, and a depth of each of the first microstructures is different from a depth of each of the second microstructures.

According to an embodiment of the present invention, each of the first microstructures and the second microstructures is a convex structure, and a height of each of the first microstructures is different from a height of each of the second microstructures.

According to an embodiment of the present invention, a first distance is formed between any two adjacent first microstructures, and a second distance is formed between any two adjacent second microstructures, and the first distance is different from the second distance.

According to an embodiment of the present invention, the light guide plate further includes plural third microstructures disposed on the light-incident surface of the main body.

According to an embodiment of the present invention, the light guide plate further includes an inclined surface connecting the light-incident surface and the first area, in which the plain area is located on the inclined surface.

According to an embodiment of the present invention, the plain area and the first area are located on the same plane.

According to an embodiment of the present invention, a backlight module is provided. The backlight module includes the aforementioned light guide plate and a light source. The light source is disposed adjacent to the light-incident surface, in which the light source includes a circuit board and plural light-emitting diodes, and the light-emitting diodes are disposed on the circuit board.

According to an embodiment of the present invention, another backlight module is provided. The backlight module includes a light source and a light guide plate. The light source includes a circuit board and plural light-emitting diodes, in which the light-emitting diodes are disposed on the circuit board. The light guide plate includes a main body, plural first microstructure portions and plural second microstructure portions. The main body includes a light-incident surface and an optical surface, in which the light-incident surface is connected to the optical surface. The first microstructure portions are disposed on the first area of the optical surface. The second microstructure portions disposed on the first area of the optical surface, in which the second microstructure portions are different from the first microstructure portions. Each of the first microstructure portions has a first contour located away from the light-incident surface, and each of the second microstructure portions has a second contour located away from the light-incident surface. Rules of alternately arranging the first microstructure portions and the second microstructure portions side by side are determined in accordance with a first distance between the first contour and the light-incident surface and a second distance between the second contour and the light-incident surface.

According to an embodiment of the present invention, when being disposed adjacent to a first baseline of the light-incident surface, the second microstructure portions and the first microstructure portions are alternately arranged in a first order of one first microstructure portion and one second microstructure portion. When being disposed adjacent to a second baseline of the light-incident surface, the second microstructure portions and the first microstructure portions are alternately arranged in a second order of one second microstructure portion and one first microstructure portion. The first order is opposite to the second order.

According to an embodiment of the present invention, each of the light-emitting diodes forms plural illumination areas on the light guide plate, such that plural bright areas and plural dark areas are formed at a first baseline of the light guide plate, in which the bright areas are located in front of the light-emitting diodes, and the dark areas are located between every two adjacent bright areas. The second microstructure portions are located in the dark areas, and the first microstructure portions are located in the bright areas.

According to an embodiment of the present invention, each of the light-emitting diodes forms plural illumination areas on the light guide plate, such that plural bright areas and plural dark areas are formed at a second baseline of the light guide plate, in which the dark areas are located in front of the light-emitting diodes, and the bright areas are located between every two adjacent dark areas. The second microstructure portions are located in the dark areas, and the first microstructure portions are located in the bright areas.

According to an embodiment of the present invention, each of the first microstructure portions has plural first microstructures, and each of the second microstructure portions has plural second microstructures. Each of the second microstructures has a more significant feature than each of the first microstructures, or the second microstructures are arranged more densely than the first microstructures.

According to an embodiment of the present invention, the light guide plate further includes plural third microstructures disposed on the light-incident surface of the main body.

According to an embodiment of the present invention, a display device is provided. The display device includes a backlight module and a display panel. The display panel is disposed in front of the light guide plate of the backlight module.

It can be known from the aforementioned embodiments of the present invention that, the light guide plate has different first microstructure portions and second microstructure portions disposed on the optical surface near the light-incident surface. Therefore, the microstructures disposed in these microstructure portions can effectively mix light leaked from a light-incident side or the inclined surface of the light guide plate, thereby reducing the non-uniform brightness phenomenon occurring on the light-incident side or the inclined surface of the light guide plate and increasing illumination uniformity of the backlight module.

### BRIEF DESCRIPTION OF THE DRAWINGS

The invention can be more fully understood by reading the following detailed description of the embodiment, with reference made to the accompanying drawings as follows:

FIG. 1A is a schematic structural diagram showing a backlight module in accordance with a first embodiment of the present invention;

FIG. 1B is a schematic top view of the backlight module in accordance with the first embodiment of the present invention;

FIG. 1C is a schematic top view of another backlight module in accordance with the first embodiment of the present invention;

FIG. 2A is a partial cross-sectional view showing a first type light guide plate in accordance with the first embodiment of the present invention;

FIG. 2B is a partial cross-sectional view showing a second type light guide plate in accordance with the first embodiment of the present invention;

FIG. 2C is a partial cross-sectional view showing a third type light guide plate in accordance with the first embodiment of the present invention;

FIG. 3A is a schematic structural diagram showing a backlight module in accordance with a second embodiment of the present invention;

FIG. 3B is a schematic top view of the backlight module in accordance with the second embodiment of the present invention;

FIG. 3C is a schematic top view of another backlight module in accordance with the second embodiment of the present invention;

FIG. 4A is a schematic structural diagram showing a backlight module in accordance with a third embodiment of the present invention;

FIG. 4B is a schematic structural diagram showing a display device in accordance with an embodiment of the present invention;

FIG. 5 is a schematic structural diagram showing a backlight module in accordance with a fourth embodiment of the present invention;

FIG. 6A is a schematic structural diagram showing a backlight module in accordance with a fifth embodiment of the present invention; and

FIG. 6B is a schematic structural diagram showing another display device in accordance with an embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

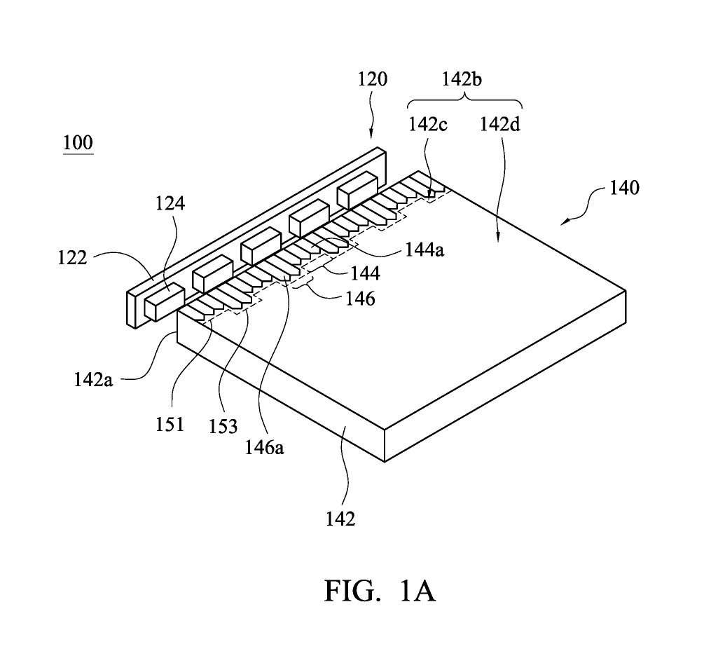

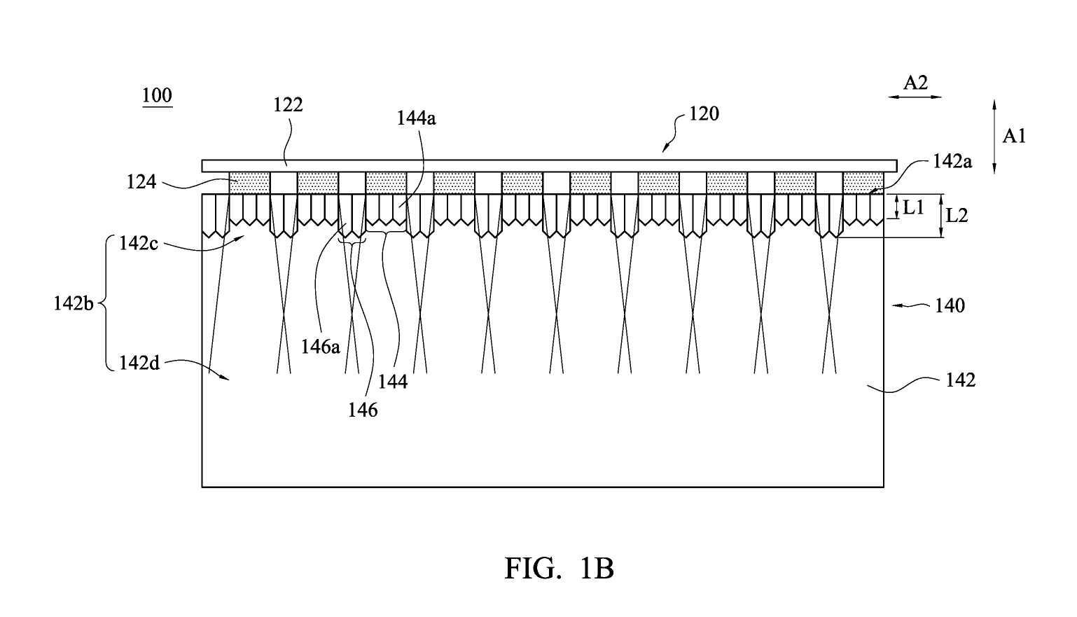

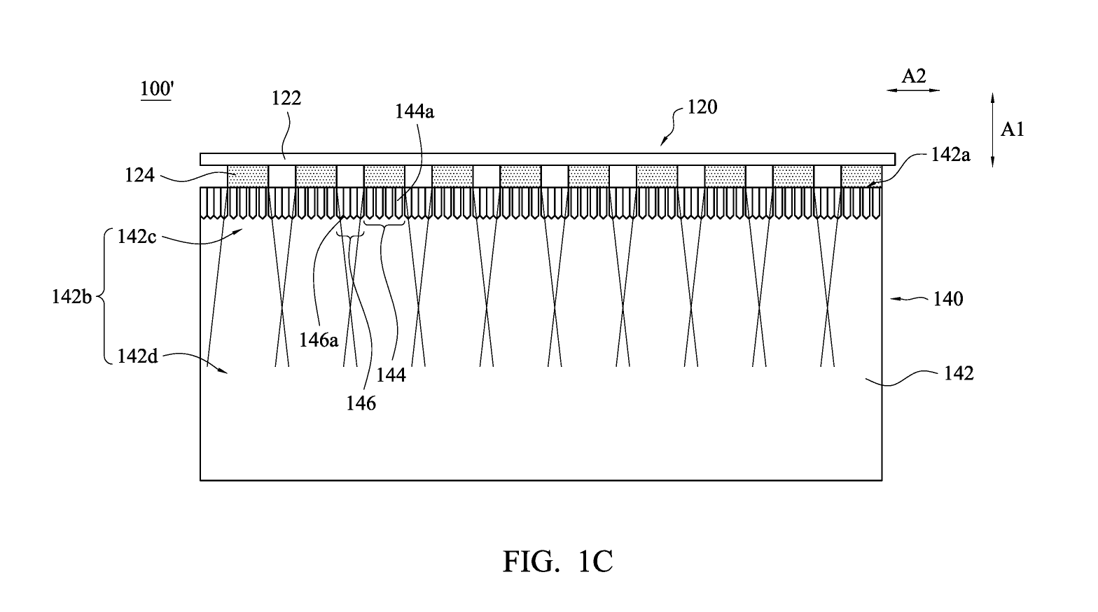

Referring to FIG. 1A and FIG. 1B, FIG. 1A and FIG. 1B are a schematic structural diagram and a schematic top view showing a backlight module 100 in accordance with a first embodiment of the present invention. The backlight module 100 of the present embodiment mainly includes a light source 120 and a light guide plate 140. The light guide plate 140 mainly includes a main body 142, plural first microstructure portions 144 and plural second microstructure portions 146. The first microstructure portions 144 and the second microstructure portions 146 are disposed on the main body 142. The first microstructure portions 144 and the second microstructure portions 146 can effectively mix light leaked from a light-incident side of the light guide plate 140, thereby reducing a non-uniform brightness phenomenon generated adjacent to the light-incident side of the light guide plate and increasing illumination uniformity of the backlight module 100.

Referring to FIG. 1A and FIG. 1B again, the main body 142 includes a light-incident surface 142a an optical surface 142b, and the light-incident surface 142a is connected to the optical surface 142b. In the present embodiment, the optical surface 142b is a light-emitting surface of the light guide plate 140. In other embodiments, the optical surface 142b can be a reflecting surface of the light guide plate 140 which is opposite to the light-emitting surface. The optical surface 142b includes a first area 142c and a second area 142d. In the present embodiment, the first area 142c is disposed adjacent to the light-incident surface 142a, and second area 142d is more farther from the light-incident surface 142a than the first area 142c. In the field of backlight modules, the first area 142c is referred to as a non-display area, and one portion of the light-emitting surface located in this area is covered by an outer frame of the backlight module. The second area 142d is referred to as an active area, and the other portion of the light-emitting surface located in this area is not covered by the outer frame of the backlight module. Moreover, the active area can be watched by the users or be a surface illumination provided for a display panel. The first microstructure portions 144 and the second microstructure portions 146 are located in the first area 142c. In one embodiment, the main body 142 has a first axial direction A1 and a second axial direction A2, and an extending direction of the first axial direction A1 is different from an extending direction of the second axial direction A2. The first area 142c and the second area 142d are arranged along the first axial direction A1. As shown in FIG. 1A and FIG. 1B, the first microstructure portions 144 and the second microstructure portions 146 are alternately arranged along the second axial direction A2 in the first area 142c. Moreover, the first microstructure portions 144 are different from the second microstructure portions 146. In some examples, the first axial direction A1 is vertical to the light-incident surface 142a, and the second axial direction A2 is parallel to light-incident surface 142a, so that the first axial direction A1 is vertical to the second axial direction A2. In one embodiment, the second area 142d can be a mirror surface without any microstructures. In other embodiments, the second area 142d can be implemented with plural dotted microstructures or striped microstructures, so as to meet practical requirements.

Each of the first microstructure portions 144 has plural first microstructures 144a, and each of the second microstructure portions 146 has plural second microstructures 146a. In the present embodiment, each of the first microstructures 144a and the second microstructures 146a is a striped microstructure, and each of the first microstructures 144a and the second microstructures 146a extends along the first axial direction A1 from the light-incident surface 142a. In the present embodiment, a length L1 of the first microstructures 144a is different from a length L2 of the second microstructures 146a. In one example, the length L1 of each of the first microstructures 144a and the length L2 of each of the second microstructures 146a can be designed according to the light intensity distribution of the light source 120. For example, as shown in FIG. 1A and FIG. 1B, the light source 120 includes a circuit board 122 and plural light-emitting diodes 124 disposed on the circuit board 122, and the light-emitting diodes 124 are spaced from each other at distances. It can be seen that the luminosity at a position facing each of the light-emitting diodes 124 is greater than the luminosity at a position between any two adjacent light-emitting diodes 124. Therefore, when the first microstructures 144a are disposed on the position facing each of the light-emitting diodes 124, and the second microstructures 146a are disposed on the position between any two adjacent light-emitting diodes 124, a feature of each of the second microstructures 146a can be designed more significant than a feature of each of the first microstructures 144a. For example, as shown in FIG. 1A and FIG. 1B, the length L1 of each of the first microstructures 144a is designed smaller than the length L2 of each of the second microstructures 146a.

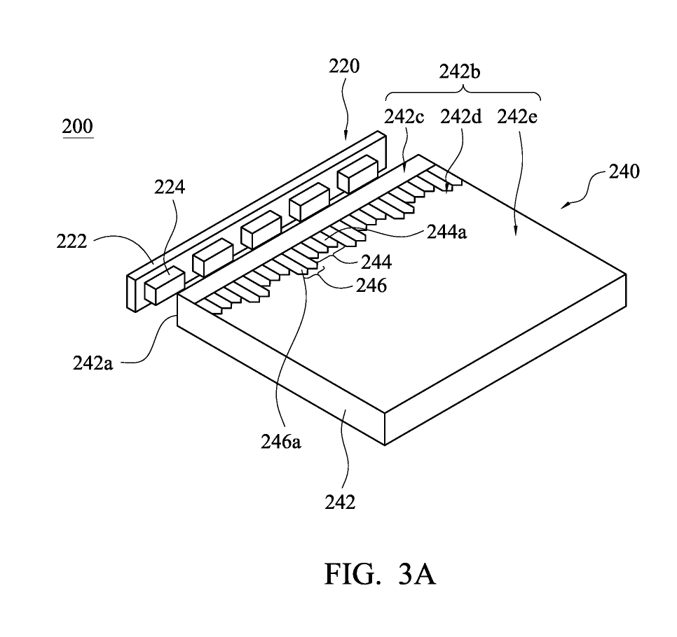

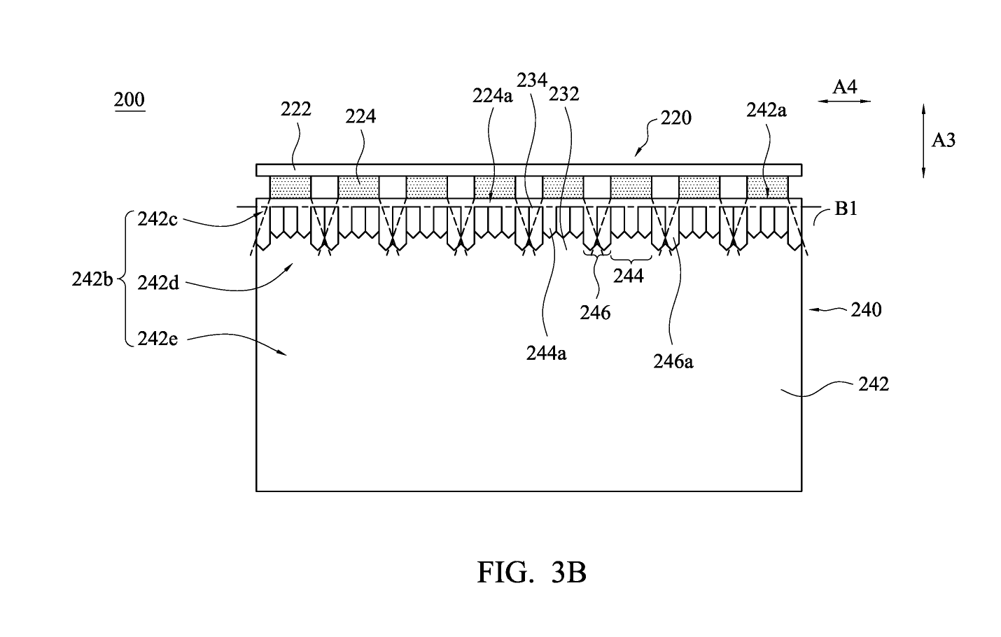

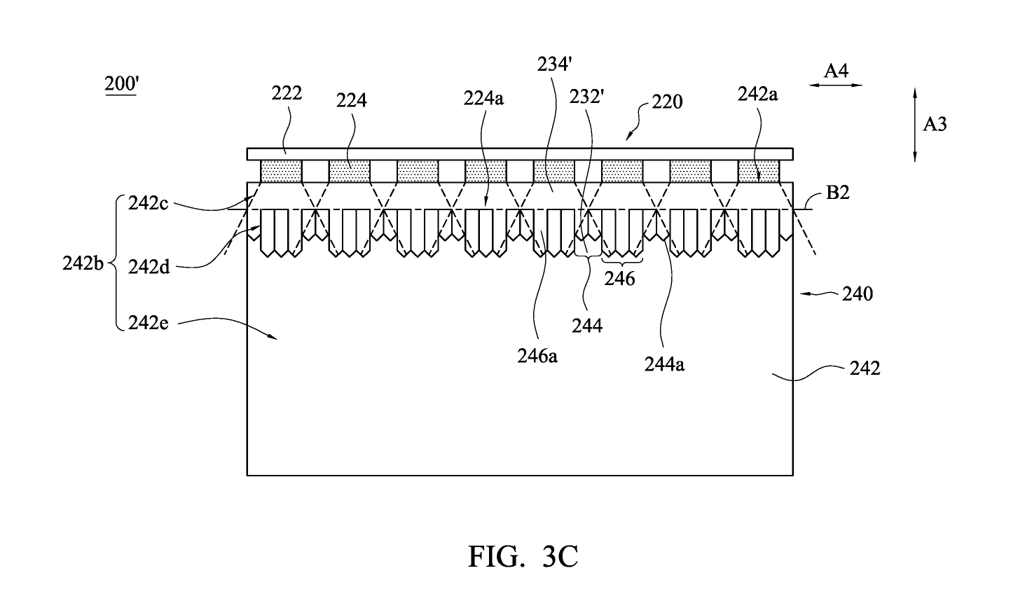

As shown in FIG. 1A, the first microstructure portions 144 have a first contour 151 located away from the light-incident surface 142a, and the second microstructure portions 146 have a second contour 153 located away from the light-incident surface 142a. The second microstructure portions 146 and the first microstructure portions 144 are alternately arranged side by side, and rules of alternately arranging the first microstructure portions 144 and the second microstructure portions 146 side by side are determined in accordance with a first distance between the first contour 151 and the light-incident surface 142a and a second distance between the second contour 153 and the light-incident surface 142a. More specifically, when the length L1 of the first microstructures 144a is different from the length L2 of the second microstructures 146a, the first contour 151 formed by ends of the first microstructures 144a away from the light-incident surface 142a is different from the second contour 153 formed by ends of the second microstructures 146a away from the light-incident surface 142a. In other words, when the lengths of the first microstructures 144a of the first microstructure portions 144 and the second microstructures 146a of the second microstructure portions 146 are different, the shapes of the first contour 151 and second contour 153 are different. In other embodiments, the shapes of the first contour 151 and second contour 153 can be designed according to a radiation pattern of the light source 120, so as to determine the arrangement rule of the first microstructure portions 144 and the second microstructure portions 146. It is noted that, in the embodiment of FIG. 1B, each of the first microstructure portions 144 is aligned with each of the light-emitting diodes 124, and the second microstructure portions 146 and the light-emitting diodes 124 are alternately arranged, such an arrangement order is different from an arrangement order of an embodiment shown in FIG. 3C. In FIG. 3C, the first microstructure portions 244 and the light-emitting diodes 224 are alternately arranged, and each of second microstructure portions 246 is aligned with each of the light-emitting diodes 224. Embodiment of FIG. 3 will be described later in detail.

In other embodiments, the length L1 of each of the first microstructures 144a and the length L2 of each of the second microstructures 146a can be designed the same, and the first microstructures 144a and the second microstructures 146a can be distinguished by variations in height or depth of first microstructures 144a and the second microstructures 146a. For example, referring to FIG. 10, FIG. 10 is a schematic top view of another backlight module 100′ in accordance with the first embodiment of the present invention. In the backlight module 100′ of FIG. 10, each of the first microstructures 144a and the second microstructures 146a has the same length, but the second microstructures 146a are arranged more densely than the first microstructures 144a.

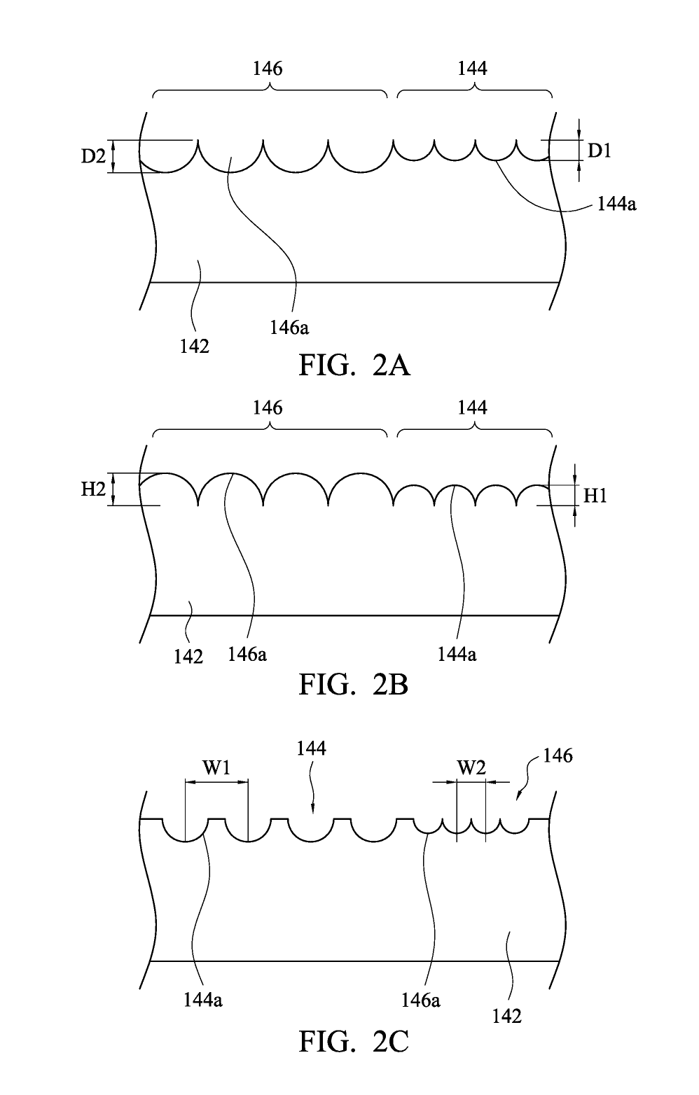

In other embodiments, features of the first microstructures 144a and the second microstructures 146a can be varied. Referring to FIG. 2A, FIG. 2A is a partial cross-sectional view showing a first type light guide plate in accordance with the first embodiment of the present invention. As shown in FIG. 2A, each of the first microstructures 144a and the second microstructures 146a is a concave structure. Each of the first microstructures 144a has a depth D1, and each of the second microstructures 146a has a depth D2. In one embodiment, the depth D1 of each of the first microstructures 144a is smaller than the depth D2 of the second microstructures 146a. In addition, the length L1 of each of the first microstructures 144a and the length L2 of each of the second microstructures 146a can be the same or different.

Referring to FIG. 2B, FIG. 2B is a partial cross-sectional view showing a second type light guide plate in accordance with the first embodiment of the present invention. As shown in FIG. 2B, each of the first microstructures 144a and the second microstructures 146a is a convex structure. Each of the first microstructures 144a has a height H1, and each of the second microstructures 146a has a height H2. In one embodiment, the height H1 is different from the height H2. In the present embodiment, the height H1 of each of the first microstructures 144a is smaller than the height H2 of each of the second microstructures 146a. In addition, the length L1 of each of the first microstructures 144a and the length L2 of each of the second microstructures 146a can be the same or different.

In some embodiments, the arrangement densities of the first microstructures 144a and the second microstructures 146a can be varied according to the positions of each of the light-emitting diodes 124. Referring to FIG. 2C, FIG. 2C is a partial cross-sectional view showing a third type light guide plate in accordance with the first embodiment of the present invention. As shown in FIG. 2C, there is a first distance W1 between any two adjacent first microstructures 144a, and there is a second distance W2 between any two adjacent second microstructures 146a. The first distance W1 is different from the second distance W2. In the present embodiment, the second distance W2 is smaller than the first distance W1. In other words, the second microstructures 146a are arranged more densely than the first microstructures 144a. In addition, the length L1 of each of the first microstructures 144a and the length L2 of each of the second microstructures 146a can be the same or different. Similarly, the height H1 (or depth D1) of the first microstructures 144a, and the height H2 (or depth D2) of the second microstructures 146a can be the same or different, so as to meet different requirements.

It is noted that, in the embodiment of FIG. 1A and FIG. 1B, the first microstructure portions 144 and the second microstructure portions 146 connected to the light-incident surface 142a is not intended to limit the scope of the present invention. In other embodiments, the first microstructure portions 144 and the second microstructure portions 146 are not connected to the light-incident surface. In other words, first microstructure portions 144 and the second microstructure portions 146 are spaced from the light-incident surface at a distance.

Simultaneously referring to FIG. 3A and FIG. 3B, FIG. 3A and FIG. 3B are a schematic structural diagram and a schematic top view showing a backlight module 200 in accordance with a second embodiment of the present invention. The backlight module 200 of the present embodiment mainly includes a light source 220 and a light guide plate 240. The light guide plate 240 mainly includes a main body 242, plural first microstructure portions 244 and plural second microstructure portions 246. The first microstructure portions 244 and the second microstructure portions 246 are disposed on the main body 242. The first microstructure portions 244 and the second microstructure portions 246 can effectively mix light leaked from a light-incident side of the light guide plate 240, so as to reduce non-uniform brightness adjacent to the light-incident side of the light guide plate and increase illumination uniformity of the backlight module 200.

Referring to FIG. 3A and FIG. 3B again, the main body 242 includes a light-incident surface 242a an optical surface 242b, and the light-incident surface 242a is connected to the optical surface 242b. The optical surface 242b includes a plain area 242c, a first area 242d and a second area 242e. In addition, the main body 242 has a first axial direction A3 and a second axial direction A4, and an extending direction of the first axial direction A3 is different from an extending direction of the second axial direction A4. In some embodiments, the first axial direction A3 is vertical to the light-incident surface 242a, and the second axial direction A4 is parallel to the light-incident surface 242a, so that the first axial direction A3 is vertical to the second axial direction A4.

As shown in FIG. 3A and FIG. 3B, in the present embodiment, the plain area 242c, the first area 242d and the second area 242e is sequentially arranged along the first axial direction A3. Moreover, the plain area 242c is connected to the light-incident surface 242a, the second area 242e is located away from the light-incident surface 242a, and the first area 242d is located between the plain area 242c and the second area 242e. In the field of backlight modules, the first area 242d and the plain area 242c are referred to as a non-display area, and one portion of the light-emitting surface located in this area is covered by an outer frame of the backlight module. The second area 242e is referred to as an active area, and the other portion of the light-emitting surface located in this area is not covered by the outer frame of the backlight module and can be watched by users. As shown in FIG. 3A and FIG. 3B, the first microstructure portions 244 and the second microstructure portions 246 are located in the first area 242d, and first microstructure portions 244 and the second microstructure portions 246 are alternately arranged side by side along the second axial direction A4. Moreover, in the present embodiment, the first microstructure portions 244 are different from the second microstructure portions 246. In one embodiment, the second area 242e can be a mirror surface without any microstructures. In other embodiments, the second area 242e can be implemented with plural dotted microstructures or striped microstructures, so as to meet practical requirements.

Referring to FIG. 3A and FIG. 3B again, the light source 220 includes a circuit board 222 and plural light-emitting diodes 224 disposed on the circuit board 222. In the present embodiment, the first microstructure portions 244 and the second microstructure portions 246 are arranged according to the light-emitting direction of the light-emitting diodes 224. As shown in FIG. 3A and FIG. 3B, light emitted from each of the light-emitting diodes 224 is scattered into the light guide plate 240, and forms plural illumination areas 224a on the light guide plate 240, such that plural bright areas 232 and plural dark areas 234 are formed at a first baseline B1 of the light guide plate 242. Each of the “bright areas 232” is referred to as the illumination areas 224a corresponding to each of the light-emitting diodes 224, and the “dark areas 234” is referred to as a weakly illumination area located between every two adjacent light-emitting diodes 224. In the present embodiment, the first microstructure portions 244 are located in the bright areas 232, and second microstructure portions 246 are located in the dark areas 234.

Referring to FIG. 3A and FIG. 3B, each of the first microstructure portions 244 has plural first microstructures 244a, and each of the second microstructure portions 246 has plural second microstructures 246a. In the present embodiment, each of the first microstructures 244a and the second microstructures 246a is a striped microstructure, and each of the first microstructures 244a and the second microstructures 246a extends along a first axial direction A3. In addition, because the first microstructure portions 244 and the second microstructure portions 246 are respectively located in the bright areas 232 and dark areas 234, each of the second microstructures 246a in the second microstructure portions 246 has a more significant feature than each of the first microstructures 244a in the first microstructure portions 244. For example, the feature of each of the second microstructures 246a is longer, deeper or taller than that of each of the first microstructures 244a. In other embodiments, the second microstructures 246a are arranged more densely than the first microstructures 244a. It is noted that, the design and the effect of the first microstructures 244a and the second microstructures 246a are similar to those of the first microstructures 144a and the second microstructures 146a, and therefore will not be described again herein.

Referring to FIG. 3C, FIG. 3C is a schematic top view of another backlight module 200′ in accordance with the second embodiment of the present invention. The structure of the backlight module 200′ in the present embodiment is similar to that of the aforementioned backlight module 200, and the main difference therebetween is that the first microstructure portions 244 and the second microstructure portions 246 of the backlight module 200′ have different arrangements. As shown in FIG. 3C, light emitted from each of the light-emitting diodes 224 is scattered into the light guide plate 240, and forms plural illumination areas 224a on the light guide plate 240, such that plural bright areas 232′ and plural dark areas 234′ are formed at a second baseline B2 of the light guide plate 242. Each of the bright areas 232′ is referred to as an overlapped area of any two adjacent illumination areas 224a, and each of the dark areas 234′ is referred to as a non-overlapped area of any two adjacent illumination areas 224a. In the present embodiment, the first microstructure portions 244 are located in the bright areas 232′, and second microstructure portions 246 are located in the dark areas 234′.

Referring to FIG. 3C again, because the first microstructure portions 244 and the second microstructure portions 246 are respectively located in the bright areas 232′ and dark areas 234′, each of the second microstructures 246a in the second microstructure portions 246 has more significant feature than each of the first microstructures 244a in the first microstructure portions 244. For example, the feature of each of the second microstructures 246a is longer, deeper or taller than that of each of the first microstructures 244a. In other embodiments, the second microstructures 246a are arranged more densely than the first microstructures 244a. It is noted that, the design and the effect of the first microstructures 244a and the second microstructures 246a are similar to those of the first microstructures 144a and the second microstructures 146a of the first embodiment in FIG. 1A to FIG. 2C, and therefore will not be described again herein.

It is noted that, in the embodiment of FIG. 3A and FIG. 3B, the illumination areas 224a are not overlapped with each other at the first baseline B1. Therefore, when being disposed adjacent to the first baseline B1, the first microstructure portions 244 and the second microstructure portions 246 are alternately arranged according to in a first order of a first microstructure portion 244 and a second microstructure portion 246. In other words, each of the first microstructure portions 244 is disposed corresponding to each of the light-emitting diodes 224, and the second microstructure portions 246 and the light-emitting diodes 224 are in alternately arranged.

In the embodiment of FIG. 3C, the illumination areas 224a are overlapped with each other at the second baseline B2. Therefore, when disposed at the second baseline B2 which is located away from the light-incident surface 242a, the first microstructure portions 244 and the second microstructure portions 246 are alternately arranged in a second order of a second microstructure 246 region and a first microstructure portion 244. In other words, the first microstructure portions 244 and the light-emitting diodes 224 are alternately arranged, and each of the second microstructure portions 246 is disposed corresponding to each of the light-emitting diodes 224. From the above, it can be seen that the aforementioned first order and the second order are determined in accordance with the location of the first baseline B1 and the second baseline B2. In one embodiment, the first order is opposite to the second order.

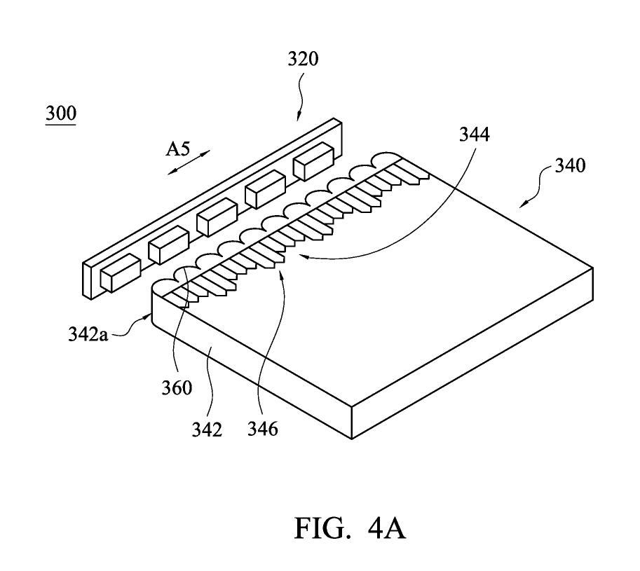

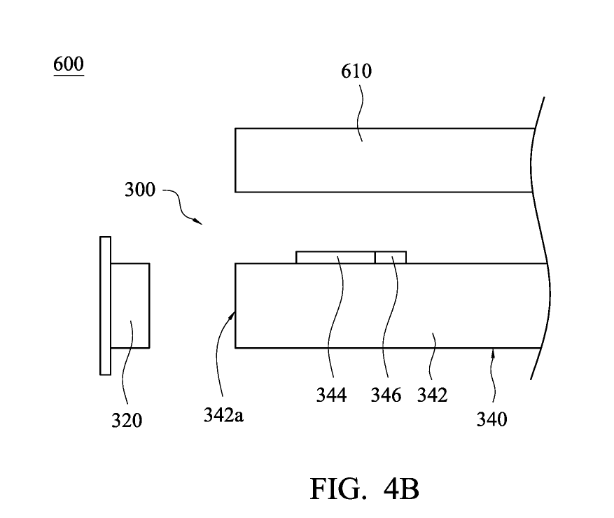

Referring to FIG. 4A, FIG. 4A is a schematic structural diagram showing a backlight module 300 in accordance with a third embodiment of the present invention. The structure of the backlight module 300 in the present embodiment is similar to that of the aforementioned backlight module 200, and the main difference therebetween is that a light guide plate 340 of the backlight module 300 has plural third microstructures 360 disposed on a light-incident surface 342a of the light guide plate 340. As shown in FIG. 4A, the backlight module 300 includes a light source 320 and the light guide plate 340. The light guide plate 340 includes a main body 342, plural first microstructure portions 344 and plural second microstructure portions 346. The first microstructure portions 344 and the second microstructure portions 346 are disposed on the main body 342. In addition, the third microstructures 360 are disposed on the light-incident surface 342a of the light guide plate 340 to spreadly diffuse light in an axial direction A5 before impinging on first microstructures in the first microstructure portions 344 and second microstructures in the second microstructure portions 346. Therefore, the angle of emitting ray from the light source 320 can be increased to reduce the area of the second microstructure portions 346. It is noted that, the design of the first microstructure portions 344 and the second microstructure portions 346 are similar to those of the aforementioned first microstructure portions 144 and 244 and the second microstructure portions 146 and 246, and therefore will not be described again herein.

Referring to FIG. 4B, FIG. 4B is a schematic structural diagram showing a display device 600 in accordance with an embodiment of the present invention. The display device 600 of the present embodiment includes the backlight module 300 as shown in FIG. 4A and a display panel 610. As shown in FIG. 4B, the display panel 610 is disposed in front of the light guide plate 340 of the backlight module 300, so as to achieve the same object as described above, and therefore will not be described again herein. It is noted that, the backlight module 300 shown in FIG. 4A is merely used as an example applied to the display device 600 for explanation, and embodiments of the present invention are not limited thereto. In other embodiments, other backlight modules, such as the backlight modules 100, 100′ or 200 also can be applied to the display device 600, so as to achieve the same effect.

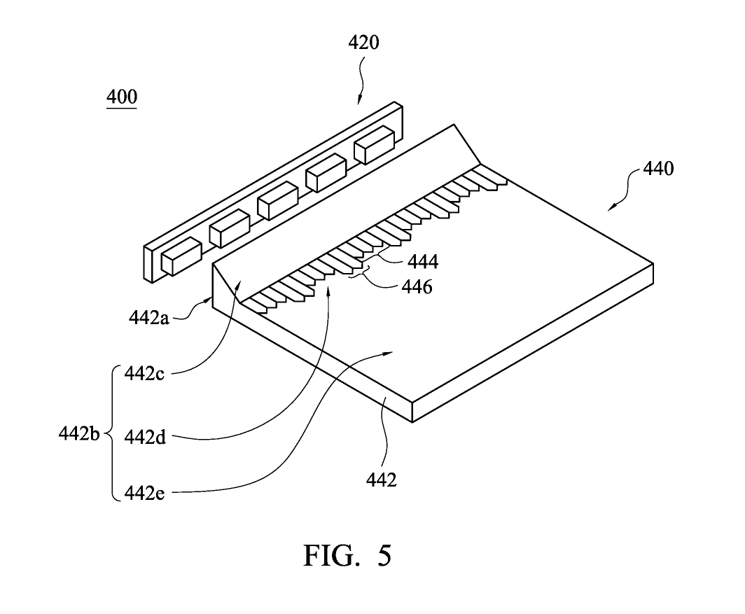

In the present invention, the main body of the light guide plate can be a plate with non-uniform thickness. Referring to FIG. 5, FIG. 5 is a schematic structural diagram showing a backlight module 400 in accordance with a fourth embodiment of the present invention. The structure of the backlight module 400 in the present embodiment is similar to that of the aforementioned backlight module 200, and the main difference therebetween is that a main body 442 of a light guide plate 440 in the backlight module 400 is a plate with non-uniform thickness.

As shown in FIG. 5, the backlight module 400 includes a light source 420 and a light guide plate 440. The light guide plate 440 includes the main body 442, plural first microstructure portions 444 and plural second microstructure portions 446. The first microstructure portions 444 and the second microstructure portions 446 are disposed on the main body 442. The main body 442 includes a light-incident surface 442a and an optical surface 442b. In the present embodiment, a thickness of the main body 442 adjacent to the light-incident surface 442a is greater than a thickness of the main body 442 away from the light-incident surface 442a to define a taper portion located on the optical surface 442b. The optical surface 442b includes a plain area 442c, a first area 442d and a second area 442e. Moreover, a portion of the optical surface 442b connected to the light-incident surface 442a is an inclined surface, and the plain area 442c of the present embodiment is disposed on the inclined surface. The first area 442d is connected to the plain area 442c and located between the second area 442d and the plain area 442c. In the present embodiment, the first microstructure portions 444 and the second microstructure portions 446 are disposed in the first area 442d. Because the thickness of the taper portion is gradually decreased, when light beam travels through the taper portion, the angle between light beam and the inclined surface is gradually increased. When the angle between light beam and the inclined surface is greater than the critical angle of the material of the light guide plate, the light beam is likely to leak from the inclined surface, thus resulting in hotspot which is more obvious than the light guide plate with uniform thickness as shown in FIG. 1A. Therefore, it is necessary to use the first microstructure portions 444 and the second microstructure portions 446 to solve problem of the hotspot. It is noted that, the design of the first microstructure portions 444 and the second microstructure portions 446 are similar to those of the aforementioned first microstructure portions 144 and 244 and the second microstructure portions 146 and 246, and therefore will not be described again herein.

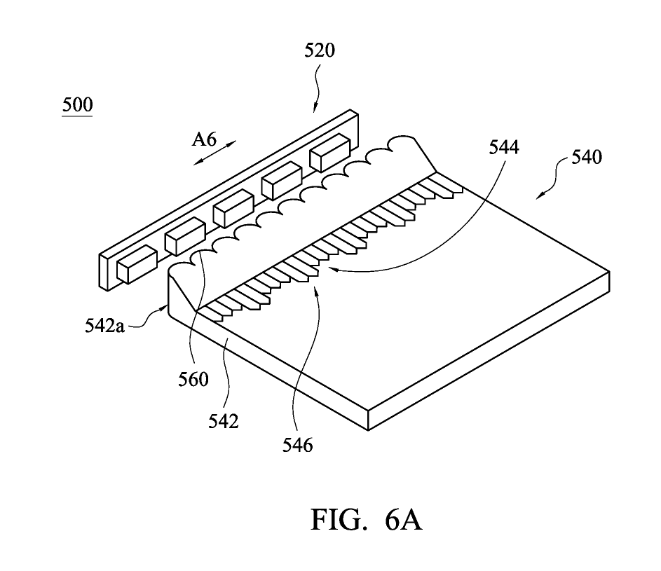

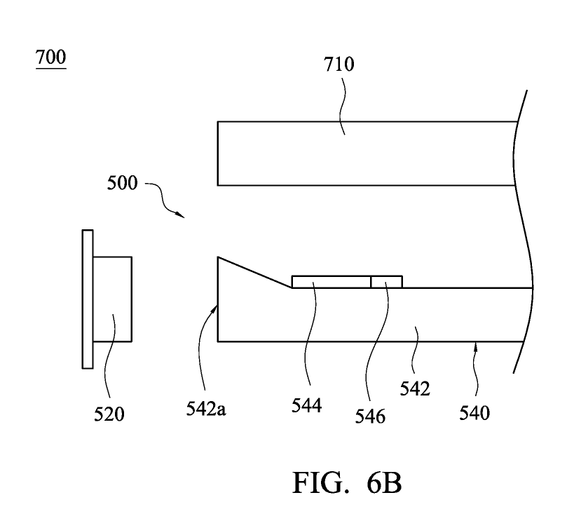

Referring to FIG. 6A, FIG. 6A is a schematic structural diagram showing a backlight module 500 in accordance with a fifth embodiment of the present invention. The structure of the backlight module 500 in the present embodiment is similar to that of the aforementioned backlight module 300, and the main difference therebetween is that a light guide plate 540 of the backlight module 500 has plural third microstructures 560 disposed on a light-incident surface 542a of the light guide plate 340. As shown in FIG. 6A, the backlight module 500 includes a light source 520 and the light guide plate 540. The light guide plate 540 includes a main body 542, plural first microstructure portions 544 and plural second microstructure portions 546. The first microstructure portions 544 and the second microstructure portions 546 are disposed on the main body 542. In addition, the third microstructures 560 are disposed on the light-incident surface 542a of the main body 542 to spreadly diffuse light in an axial direction A6 before impinging on first microstructures in the first microstructure portions 544 and the second microstructures in the second microstructure portions 546. Therefore, the angle of emitting ray from the light source 520 can be increased to reduce the area of the second microstructure portions 546. It is noted that, the design of the first microstructure portions 544 and the second microstructure portions 546 are similar to those of the aforementioned first microstructure portions 144 and 244 and the second microstructure portions 146 and 246, and therefore will not be described again herein.

Referring to FIG. 6B, FIG. 6B is a schematic structural diagram showing another display device 700 in accordance with an embodiment of the present invention. The display device 700 includes the backlight module 500 shown in FIG. 6A and a display panel 710. As shown in FIG. 6B, the display panel 710 is disposed in front of the backlight module 500, so as to achieve the same object as described above, and therefore will not be described again herein. It is noted that, the backlight module 500 shown in FIG. 6A is merely used as an example applied to the display device 700 for explanation, and embodiments of the present invention are not limited thereto. In other embodiments, other backlight modules of the aforementioned embodiments, such as the backlight module 400 also can be applied to a display device, so as to achieve the same effect.

It can be known from the aforementioned embodiments of the present invention that, the light guide plate has different first microstructure portions and second microstructure portions disposed on the optical surface near the light-incident surface. Therefore, the microstructures disposed in these microstructure portions can effectively mix light leaked from a light-incident side or the inclined surface of the light guide plate, thereby reducing the non-uniform brightness phenomenon occurring on the light-incident side or the inclined surface of the light guide plate and increasing illumination uniformity of the backlight module.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A light guide plate, comprising:
a main body comprising a light-incident surface and an optical surface, wherein the light-incident surface is connected to the optical surface, and the optical surface includes a first area;
a plurality of first microstructure portions disposed on the first area of the optical surface; and
a plurality of second microstructure portions disposed on the first area of the optical surface, wherein the second microstructure portions and the first microstructure portions are alternately arranged and aligned with each other, and the first microstructure portions are different from the second microstructure portions.

2. The light guide plate of claim 1, wherein each of the first microstructure portions has a plurality of first microstructures extending along a first axial direction, and each of the second microstructure portions has a plurality of second microstructures extending along the first axial direction, and the first microstructure portions and the second microstructure portions are alternately arranged along a second axial direction which is different from the first axial direction.

3. The light guide plate of claim 1, wherein the optical surface further includes a plain area located between the light-incident surface and the first area.

4. The light guide plate of claim 3, wherein the plain area and the first area are arranged along a first axial direction, and the second microstructure portions and the first microstructure portions are arranged along a second axial direction which is different from the first axial direction.

5. The light guide plate of claim 4, wherein each of the first microstructure portions has a plurality of first microstructures extending along a first axial direction, and each of the second microstructure portions has a plurality of second microstructures extending along the first axial direction.

6. The light guide plate of claim 2, wherein a length of each of the first microstructures is different from a length of each of the second microstructures.

7. The light guide plate of claim 2, wherein each of the first microstructures and the second microstructures is a concave structure, and a depth of each of the first microstructures is different from a depth of each of the second microstructures.

8. The light guide plate of claim 2, wherein each of the first microstructures and the second microstructures is a convex structure, and a height of each of the first microstructures is different from a height of each of the second microstructures.

9. The light guide plate of claim 2, wherein a first distance is formed between any two adjacent first microstructures, and a second distance is formed between any two adjacent second microstructures, and the first distance is different from the second distance.

10. The light guide plate of claim 1, further comprising a plurality of third microstructures disposed on the light-incident surface of the main body.

11. The light guide plate of claim 3, further comprising an inclined surface connecting the light-incident surface and the first area, wherein the plain area is located on the inclined surface.

12. The light guide plate of claim 3, wherein the plain area and the first area are located on the same plane.

13. A backlight module, comprising:
a light guide plate as claimed in claim 1; and
a light source disposed adjacent to the light-incident surface, wherein the light source comprises a circuit board and a plurality of light-emitting diodes, and the light-emitting diodes are disposed on the circuit board.

14. A display device, comprising:
a backlight module as claimed in claim 13, and
a display panel disposed in front of the light guide plate of the backlight module.

15. A backlight module, comprising:
a light source comprising a circuit board and a plurality of light-emitting diodes, wherein the light-emitting diodes are disposed on the circuit board; and
a light guide plate comprising:
a main body comprising a light-incident surface and an optical surface, wherein the light-incident surface is connected to the optical surface;
a plurality of first microstructure portions disposed on the first area of the optical surface; and
a plurality of second microstructure portions disposed on the first area of the optical surface, wherein the second microstructure portions are different from the first microstructure portions;
wherein each of the first microstructure portions has a first contour located away from the light-incident surface, and each of the second microstructure portions has a second contour located away from the light-incident surface, and rules of alternately arranging the first microstructure portions and the second microstructure portions side by side are determined in accordance with a first distance between the first contour and the light-incident surface and a second distance between the second contour and the light-incident surface.

16. The backlight module of claim 15, wherein
when being disposed adjacent to a first baseline of the light-incident surface, the second microstructure portions and the first microstructure portions are alternately arranged in a first order of one first microstructure portion and one second microstructure portion; and
when being disposed adjacent to a second baseline of the light-incident surface, the second microstructure portions and the first microstructure portions are alternately arranged in a second order of one second microstructure portion and one first microstructure portion;
wherein the first order is opposite to the second order.

17. The backlight module of claim 15, wherein each of the light-emitting diodes forms a plurality of illumination areas on the light guide plate, such that a plurality of bright areas and a plurality of dark areas are formed at a first baseline of the light guide plate, wherein the bright areas are located in front of the light-emitting diodes, and the dark areas are located between every two adjacent bright areas, and the second microstructure portions are located in the dark areas, and the first microstructure portions are located in the bright areas.

18. The backlight module of claim 15, wherein each of the light-emitting diodes forms a plurality of illumination areas on the light guide plate, such that a plurality of bright areas and a plurality of dark areas are formed at a second baseline of the light guide plate, wherein the dark areas are located in front of the light-emitting diodes, and the bright areas are located between every two adjacent dark areas, and the second microstructure portions are located in the dark areas, and the first microstructure portions are located in the bright areas.

19. The backlight module of claim 15, wherein each of the first microstructure portions has a plurality of first microstructures, and each of the second microstructure portions has a plurality of second microstructures, wherein each of the second microstructures has a more significant feature than each of the first microstructures, or the second microstructures are arranged more densely than the first microstructures.

20. The backlight module of claim 15, wherein the light guide plate further comprises a plurality of third microstructures disposed on the light-incident surface of the main body.

21. A display device, comprising:
a backlight module as claimed in claim 15, and
a display panel disposed in front of the light guide plate of the backlight module.
